(19) United States
(12) Patent Application Publication
(10) Pub. No.: US 2009/0225227 A1
(43) Pub. Date: Sep. 10, 2009

(54) MOTION VECTOR DETECTING DEVICE

(75) Inventors: Kazushi NOZAWA, Okayama (JP); Yuji NAGAISHI, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/397,737

(22) Filed: Mar. 4, 2009

(30) Foreign Application Priority Data
Mar. 5, 2008 (JP) 2008-054416
Mar. 5, 2008 (JP) 2008-054417

(51) Int. Cl. H04N 5/14

(52) U.S. Cl. 348/699; 348/E05.062

(57) ABSTRACT

In the calculation of a motion vector, a motion vector of different block with a small correlation value is considered in addition to an estimated motion vector of a target block. This different block is a block at a position where a movement similar to the target block is predicted. As a result, a motion vector with a small correlation value for the different block is adopted even if a correlation value for an estimated motion vector of the target block is large. This enables the detection of a highly reliable motion vector.

### BACKGROUND

1. Technical Field

The technical field relates to technology for detecting motion vector from image signals, and in particular, motion vector detecting devices that improve accuracy of detecting motion vectors.

2. Background

A conventional detector for detecting a motion vector from an image signal is configured based on the block-matching technique. The motion vector detecting device adopting the block-matching technique divides a target image into multiple blocks, and evaluates a degree of correlation between a target block to detect the movement and each of multiple candidate areas (candidate blocks) within a predetermined search area in previous and subsequent frames of a target image. Then, a candidate block with the highest degree of correlation is chosen from the candidate blocks. Displacement between this chosen candidate block and target block is set as a motion vector.

Another structure is also disclosed. An average motion vector detected in blocks in the horizontal direction, including the target block, or blocks in the vertical direction, including the target block, is used as one of the aforementioned candidate blocks. This structure improves a motion detecting performance.

Still another structure is disclosed. If the target block is a boundary block of the image, a representative value for motion vector detected in blocks in the horizontal direction, including the target block, or blocks in the vertical direction, including the target block, is assigned. This structure improves a motion detecting performance.

The above conventional structures are disclosed in Japanese Patent Unexamined Publication No. 2005-287047 and Japanese Patent Unexamined Publication No. 2005-287048.

However, the above motion vector detecting devices may not be able to effectively detect correct motion vectors that should be detected in detecting motion vectors from image signals. For example, in an image in which multiple objects move differently, such as an object and background moving in different directions, this problem tends to occur at a boundary area of moving object due to the presence of multiple movements.

### SUMMARY

A motion vector detecting device includes a motion vector estimator, a motion vector converter, a correlation calculator, and a motion vector determinator.

The motion vector estimator calculates an estimated motion vector that is a motion vector estimated for a reference block in a partial area of a display screen configuring an image signal, and a correlation value between an estimated block pointed by the estimated motion vector and the reference block.

The motion vector converter calculates a second reference block in response to a first estimated motion vector calculated by applying the motion vector estimator to the first reference block.

The correlation value calculator calculates a second correlation value that is a correlation value calculated by applying the motion vector estimator to the second reference block.

The motion vector determinator determines and outputs a motion vector of the second reference block based on at least one of:
at least one of the first correlation value calculated by applying the motion vector estimator to the first reference block or the second correlation value;
the first estimated motion vector; or
the second estimated motion vector calculated by applying the motion vector estimator to the second reference block.

Another motion vector detecting device includes a motion vector estimator, a representative motion vector generator, a motion vector converter, a correlation value calculator, and a motion vector determinator.

The motion vector estimator calculates an estimated motion vector that is a motion vector estimated for a reference block in a partial area of a display screen configuring an image signal, and a correlation value between an estimated block pointed by the estimated motion vector and the reference block.

The representative motion vector generator calculates a representative motion vector that represents the multiple estimated motion vectors based on the multiple estimated motion vectors and the correlation value.

The motion vector converter calculates a second reference block in response to a first representative motion vector calculated by applying the motion vector estimator and the representative vector generator to the first reference block.

The correlation value calculator obtains a second correlation value that is a correlation value calculated by applying the motion vector estimator to the second reference block.

The motion vector determinator determines and outputs a motion vector of the second reference block based on at least one of:
the second correlation value
the first representative motion vector, or
the second estimated motion vector calculated by applying the motion vector estimator to the second reference block.

### BRIEF DESCRIPTION OF THE DRAWINGS

FIG. 1 illustrates an example of a structure of a motion vector detecting device in accordance with a first exemplary embodiment.

FIG. 2 illustrates an example of a structure of a motion vector estimator.

FIG. 3 illustrates a search range for estimating a motion vector.

FIG. 4 is an example of differences for calculating correlation values between blocks.

FIG. 5 illustrates the relationship among a reference block, a target block, and an estimated block calculated by a motion vector converter and a correlation value calculator.

FIG. 6 illustrates the relationship among the reference block, the target block, and the estimated block.

FIG. 7 is an example of a structure of a motion vector detecting device in accordance with a second exemplary embodiment.

FIG. 8 is an example of a structure of a representative motion vector generator.

FIG. 9 is an example of a hardware configuration for software process for detecting a motion vector in accordance with a third exemplary embodiment.

### DETAILED DESCRIPTION

In view of aforementioned disadvantage of prior art, the exemplary embodiments enable the effective detection of highly-accurate motion vectors.

Exemplary embodiments are described below with reference to drawings. All numeric values in the description are given as examples and thus the exemplary embodiments are not limited to the given numeric values.

### First Exemplary Embodiment

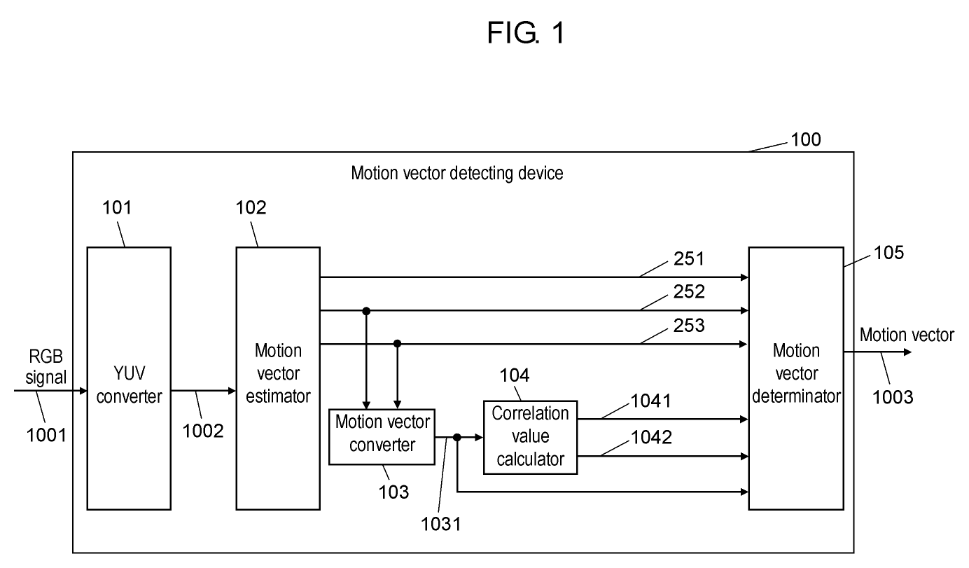

FIG. 1 is a functional block diagram illustrating a structure of a motion vector detecting device in the first exemplary embodiment. The motion vector detecting device in the first exemplary embodiment receives an RGB signal as an image signal, typically for a motion picture or a still picture, and outputs a motion vector. The RGB signal is a signal configured with a red signal, green signal, and blue signal.

In FIG. 1, motion vector detecting device 100 includes YUV converter 101, motion vector estimator 102, motion vector converter 103, correlation value calculator 104, and motion vector determinator 105.

YUV converter 101 converts RGB signal 1001, which is an input image signal, to YUV signal 1002. More specifically, YUV converter 101 converts RGB signal 1001 defined by RGB color space to YUV signal 1002 defined by YUV color space. YUV signal 1002 is a signal configured with a luminance signal, Cb signal, and Cr signal. YUV converter 101 is inserted in order to maintain consistency between input RGB signal 1001 and a signal to be input to later processes. Accordingly, YUV converter 101 is not necessary if inputs to motion vector detecting device 100 and motion vector estimator 102 adopt a common signal format. In addition, conversion in this converter needs to be changed appropriately, depending on the combination of a signal input from outside to motion vector detecting device 100 and a signal needed in later processes.

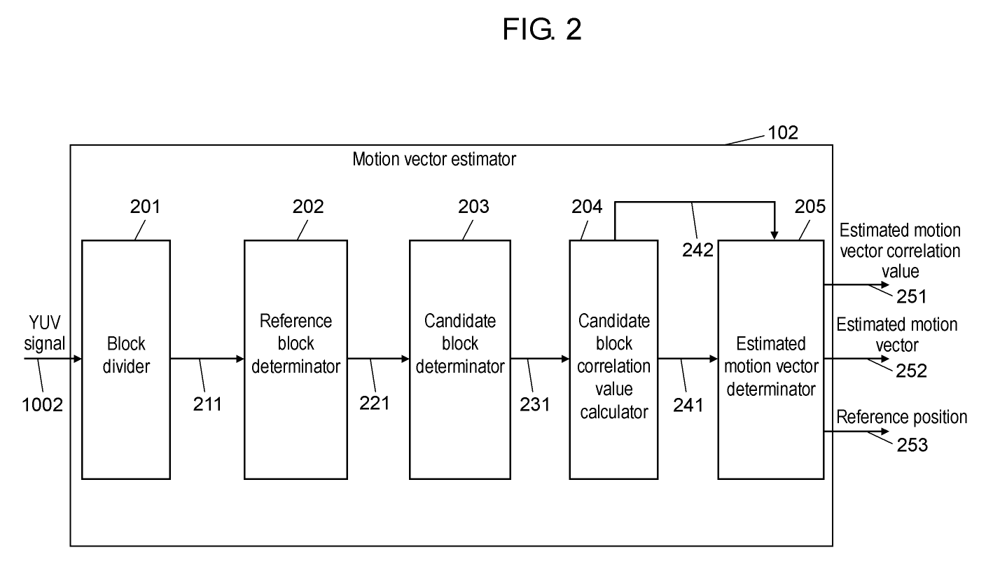

Motion vector estimator 102 estimates a motion vector based on YUV signal 1002. A specific structure of motion vector estimator 102 is given in FIG. 2.

FIG. 2 shows an example of a specific structure of motion vector estimator 102. Motion vector estimator 102 includes block divider 201, reference block determinator 202, candidate block determinator 203, candidate block correlation value calculator 204, and estimated motion vector determinator 205. Block divider 201 divides a frame image (display image) of YUV signal 1002 input from YUV converter 101 into multiple areas. Hereafter, each of divided areas is called a block. Block divider 201 outputs divided multiple blocks 211. These blocks are partial areas of the display image configuring the image signal.

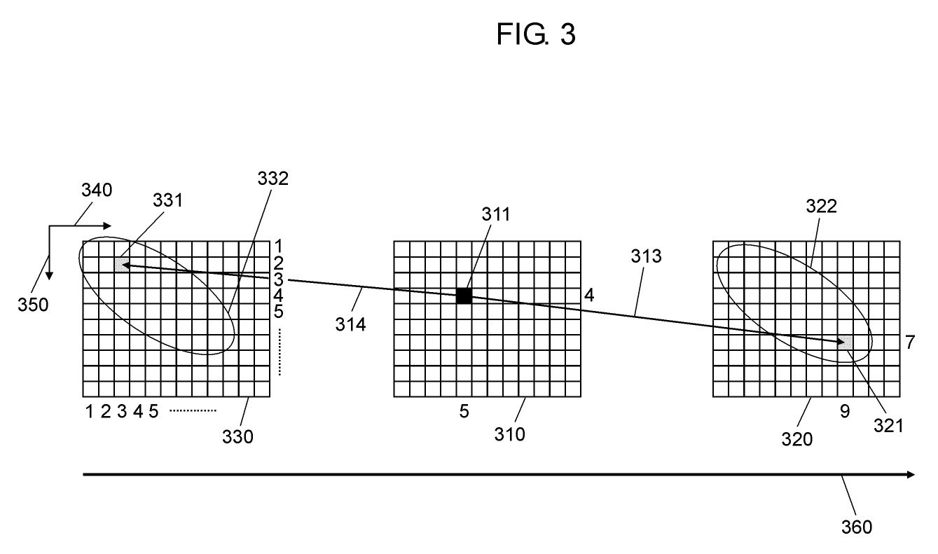

FIG. 3 illustrates how the motion vector is estimated. In FIG. 3, present frame 310 is a present frame of YUV signal 1002 input to block divider 201. Subsequent frame 320 is one frame after frame 310 in terms of time, and previous frame 330 is one frame before frame 310 in terms of time. Arrow 360 indicates the flow of time. Arrow 340 indicates a horizontal direction, and arrow 350 indicates a vertical direction. To facilitate description, present frame 310, subsequent frame 320, and previous frame 330 are divided into 12 blocks in the direction of arrow 340, and 10 blocks in the direction of arrow 350, respectively. These blocks correspond to blocks 211 output from block divider 201. Reference block 311 is the fourth block in the direction of arrow 350 and fifth block in the direction of arrow 340 in present frame 310. Reference block 311 is a focus block in present frame 310. Search area 322 is an area searched in subsequent frame 320 of reference block 311. Search area 332 is an area searched in previous frame 330 of reference block 311. Candidate block 321 is a candidate block in subsequent frame 320 relative to reference block 311. Candidate block 331 is a candidate block in previous frame 330 relative to reference block 311. Candidate block 321 is the seventh block in the direction of arrow 350 and the ninth block in the direction of arrow 340 in subsequent frame 320. Candidate block 331 is the second block in the direction of arrow 350 and the third block in the direction of arrow 340 in previous frame 330. Estimated motion vector 313 is an estimated motion vector when reference block 311 and candidate block 321 are combined. Estimated motion vector 314 is an estimated motion vector when reference block 311 and candidate block 331 are combined.

Reference block determinator 202 sets and outputs reference block 221 in turn from divided blocks 211 so as to cover the entire area of frame image. Reference block 311 in FIG. 3 is one of reference blocks 221 output from reference block determinator 202. Here, reference block 211 is a block that becomes a starting point of a motion vector to be estimated or detected.

Candidate block determinator 203 determines candidates of estimated motion vector starting from reference block 221 output from reference block determinator 202, in a predetermined search area, and outputs multiple candidate blocks 231. Further description is given supposing that reference block 221 output from reference block determinator 202 is reference block 311 in FIG. 3. Candidate block determinator 203 determines and outputs multiple candidate blocks 321 and 331, which are candidates of estimated motion vector starting from reference block 311, as candidate blocks 231. Candidate blocks 321 and 331 are candidate blocks found in search areas 322 and 332.

As one way of setting predetermined search areas 322 and 332, the entire frame of subsequent frame 320 and previous frame 330 may be set as the search area. In this case, all blocks 211 included in a frame image will be searched. This type of search is called the all-search system. The reliability of estimated motion vector calculated improves in the all-search system. Alternatively, only a part of frame image may be set as predetermined search areas 322 and 332. This is called the partial-search system. An amount of calculation may be relatively reduced in the partial-search system.

As shown in FIG. 3, search areas 322 and 332 are set as predetermined areas in one or more frames including at least the previous frame or the subsequent frame in the direction of arrow 360 in terms of time, relative to present frame 310 including reference block 311.

Candidate block correlation value calculator 204 calculates a correlation value between reference block 221 and each candidate block 231 for all candidate blocks 231, respectively. This correlation value is the sum of absolute values of differences between corresponding pixels in reference block 221 and candidate block 231. Or, it is the sum of square values of differences between corresponding pixels in reference block 221 and candidate block 231. Calculation of this correlation value is not limited to the methods described above. Any method that outputs a smaller value as the degree of approximation between the blocks becomes larger is applicable.

In calculation of a difference value between pixels, each pixel is configured with Y signal, which is a luminance signal, Cb signal, and Cr signal if the signal adopts the YUV format. Accordingly, a difference in all signal components (Y, Cb, and Cr) may be calculated. In this method, however, the amount of calculation increases. To complete calculation faster, a correlation value only for luminance signal Y, which has a large influence on image, may be calculated. Since calculation for the Cb signal and Cr signal is omitted in this method, a correlation value can be calculated faster.

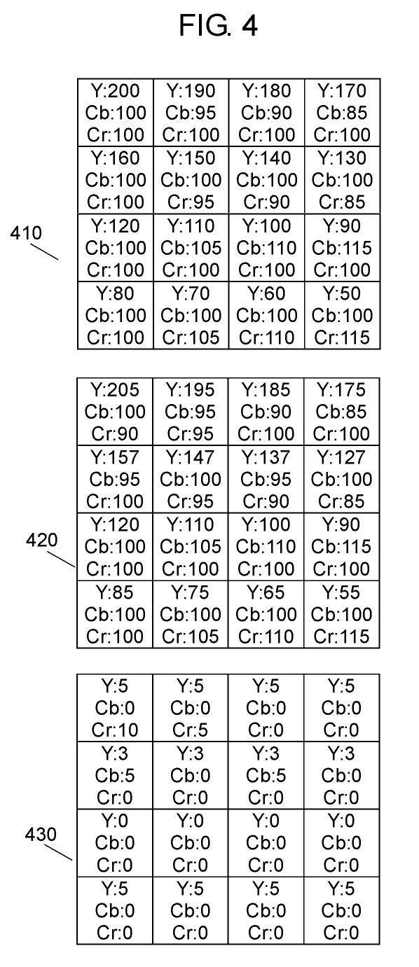

FIG. 4 shows examples of differences used for calculating a correlation value between the blocks. In FIG. 4, reference block 410 corresponds to, for example, reference block 311 in FIG. 3. Candidate block 420 corresponds to, for example, candidate block 321 or candidate block 331 in FIG. 3. To make the description simple, FIG. 4 shows the example in which reference block 410 and candidate block 420 consist of four pixels in the horizontal direction (the direction of arrow 340) and four pixels in the vertical direction (the direction of arrow 350), respectively. Values of Y signal, Cb signal, and Cr signal in each pixel are indicated. Difference absolute-value 430 indicates the absolute value of difference between reference block 410 and candidate block 420. In difference absolute-value 430 where the topmost row crosses with the leftmost column, “Y: 5,” “Cb: 0,” and Cr: 10” are indicated. They are difference absolute-values between values in the topmost row crossing with the leftmost column of reference block 410 and values in the topmost row crossing with the leftmost column of candidate block 420. In the topmost row crossing with the leftmost column of reference block 410, “Y: 200,” “Cb: 100,” and “Cr: 100” are indicated. Therefore, a value for Y signal in this pixel is “200,” a value for Cb signal is “100,” and a value for Cr signal is “100.” In the topmost row crossing with the leftmost column of candidate block 420, “Y: 205,” “Cb: 100,” and “Cr: 90” are indicated. Therefore, a value for Y signal in this pixel is “205,” a value for Cb signal is “100,” and a value for Cr signal is “90.” Accordingly, a difference absolute-value between these Y signals is “5.” a difference absolute-value between these Cb signals is “0,” and a difference absolute-value between Cr signals is “10.” Therefore, “Y: 5,” “Cb: 0,” and “Cr: 10” are indicated in the topmost row crossing with the leftmost column of difference absolute-value 430. Other pixels are calculated in the same way.

In the case shown in FIG. 4, the sum of difference absolute-values, for “Y,” “Cb,” and “Cr” of all pixels, i.e., the sum of values indicated under difference absolute-value 430, will be “77.” The value calculated in this way is called the sum of difference absolute-values, and thus a correlation value obtained from the sum of difference absolute-values is “77.” On the other hand, the sum of square values of each of difference values for “Y,” “Cb,” and “Cr” of all pixels, i.e., the sum of square values of those indicated under difference absolute-value 430 will be “411.” A value calculated in this way is called the sum of squared difference values, and a correlation value obtained from the sum of squared difference values is “411.” Alternatively, if only the luminance signal in all pixels is taken into account, i.e., only “Y,” the sum of difference absolute-values will be “52,” and the sum of squared difference values will be “236.”

Estimated motion vector determinator 205 determines a candidate block with the highest correlation from candidate blocks whose correlation values are calculated by candidate block correlation value calculator 204, as a destination block of reference block 311. The candidate block with the highest correlation means the candidate block with the smallest correlation value. The destination block of reference block 311 is also called an estimated block. Estimated motion vector determinator 205 outputs estimated motion vector 252, estimated motion vector correlation value 251, and reference position 253. Estimated motion vector 252 is a vector that starts from reference block 311 and ends at the estimated block. Estimated motion vector correlation value 251 is a correlation value between reference block 311 and the estimated block, which are pointed by this estimated motion vector 252. Reference position 253 is the position of reference block 311 on a frame.

Motion vector estimator 102 sets, in turn, each of all blocks divided by block divider 201 as a reference block. Then, motion vector estimator 102 calculates and outputs estimated motion vector 252, estimated motion vector correlation value 251, and reference position 253 for each reference block.

Next, motion vector converter 103 generates another motion vector by converting input estimated motion vector 352, based on estimated motion vector 252 calculated by motion vector estimator 102, and refers to a target block. This new motion vector is called converted vector 1031.

There are a several ways of converting the motion vector by motion vector converter 103. One of them is described below as an example.

For example, if the entire screen uniformly moves, or if a major subject composing the screen moves, a relatively large area of an image moves in the same way. In this case, blocks around reference block 311 have high chances of having a motion vector similar to that of reference block 311 in calculation of estimated motion vector 252 by motion vector estimator 102.

With regard to the movement of the image, the entire screen or a subject may move in the uniform direction. Taking this uniformity into consideration, a block positioned in substantially the same direction as an estimated motion vector estimated by motion vector estimator 102 in blocks around reference block 311 also has high chances of having a motion vector value similar to reference block 311.

Therefore, motion vector converter 103 executes conversion of motion vector 252, which is the output of motion vector estimator 102, mainly related to its direction.

Specific conversion that takes place in motion vector converter 103 includes calculation of a motion vector with almost the same size in a direction opposite to that of estimated motion vector 252, or to a motion vector with almost the same size in the same direction as that of the vector. In short, a vector with the same size in a direction substantially the same as or opposite to that of input estimated motion vector 252 is calculated.

If motion vector converter 103 converts to a motion vector with the same size in a direction opposite to that of input estimated motion vector 252, estimation is controlled to a forward direction of the movement of reference block 311. On the other hand, if motion vector converter 103 converts to a motion vector with the same size in the same direction to that of input estimated motion vector 252, estimation is controlled to a backward direction of the movement of reference block 311.

Another specific conversion by motion vector converter 103 is to add a vector with a predetermined size in substantially the same direction to input estimated motion vector 252. Alternatively, motion vector converter 103 may multiply the input motion vector by a predetermined multiplier.

A vector converted by motion vector converter 103 is called converted vector 1031. A block specified by this converted vector 1031 is called a target block. Motion vector converter 103 newly generates a combination of reference block 311, which becomes a starting point of converted vector 1031, and target block 530, which becomes a terminal point of converted vector 1031.

A control that takes place when vector converter 103 adds input estimated motion vectors 313 and 314 and a vector with a predetermined size and substantially the same or opposite direction, so as to change the estimated motion vector, is described next. In this case, a displacement distance between reference block 331 and target block 530 can be controlled to increase or decrease independently from the estimated motion vector detected in reference block 331.

A control that takes place when vector converter 103 multiplies the input estimated motion vector by a predetermined multiplier, so as to change the vector size, is described next. In this case, the displacement distance between reference block 331 and target block 530 can be controlled to increase or decrease subserviently relative to the estimated motion vector detected in reference block 331.

This estimated motion vector, which is the output of motion vector estimator 102, has horizontal and vertical components of image signal, and these components are finite values. Converted motion vector 1031, which is the output of motion vector converter 103, also has horizontal and vertical components of image signal, and these components are finite values.

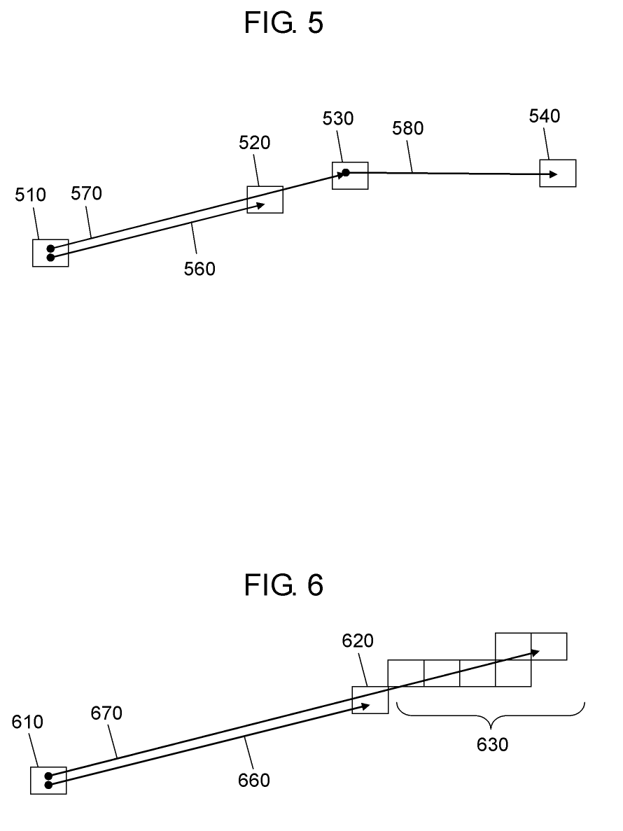

This is described with reference to FIG. 5. FIG. 5 illustrates the relationship among reference block 510, target block 530, and estimated block 520, which are calculated by motion vector converter 103 and correlation value calculator 104.

Reference block 510 in the present frame corresponds to reference block 311 in FIG. 3. Motion vector converter 103 sets converted motion vector 570 relative to the reference position of reference block 510. Converted motion vector 570 corresponds to converted motion vector 1031. Accordingly, motion vector converter 103 can determine the position of a new block relative to the direction and size of corresponding estimated vector 560, setting the reference position of reference block 510 as a starting point. This new block is a target block 530.

This target block 530 is a block with a high possibility of taking a motion vector similar to this reference block 510 around reference block 510.

Estimated block 520 is determined relative to reference block 510, and thus estimated motion vector 560 is defined. In addition, estimated block 540 of target block 530 is determined relative to target block 530, and thus estimated motion vector 580 of target block 530 is defined.

Target block 530 is not limited to one block relative to one reference block 510. For example, a block through which a vector starting from the position of reference block 510 on the screen and ending at the position of one target block passes can also be set as a target block. To describe this case, FIG. 6 illustrates the relationship among reference block 610, target block 630, and estimated block 620.

In FIG. 6, reference block 610 and estimated block 620 correspond to reference block 510 and estimated block 520 in FIG. 5, respectively. In addition, estimated motion vector 660 and converted motion vector 670 correspond to estimated motion vector 560 and converted motion vector 570 in FIG. 5, respectively. Multiple target blocks 630 are multiple blocks that exist at positions where converted motion vector 670 from reference block 610 passes through.

In this case, reference block 610 may have the motion vector to multiple target blocks 630. Contrary, no target block may be assigned to all reference blocks. In this case, this reference block 610 has no destination to move to on the screen.

In the above description, converted motion vector 670 is a vector generated by adding a vector with a predetermined size in substantially the same direction as estimated motion vector 660 to estimated motion vector 660. Furthermore, the size of the vector to be added may be dynamically changed, based on characteristics of input image signal, such as a moving direction of the entire screen, motion magnitude, or a position where a clear boundary exists on the screen.

Also in the above description, converted motion vector 670 may also be a vector generated by multiplying estimated motion vector 660 by a predetermined multiplier. This may also be dynamically changed, based on characteristics of input image signal. In that case an appropriate motion vector is detectable by input image signal.

As shown in FIGS. 1 and 5, correlation value calculator 104 outputs correlation value 1041 calculated by motion vector estimator 102 when target block 530 set by motion vector converter 103 is set as the reference block. In other words, correlation value calculator 104 calculates the same value as a correlation value for target block 530 calculated by motion vector estimator 102.

If motion vector estimator 102 calculates the correlation value for each of all blocks composing a frame, the next becomes feasible: The correlation value calculator 104 can calculate the original correlation value for target block 530 by utilizing (obtaining) the calculation result from motion vector estimator 102 without repeating the same calculation.

Another method is that correlation value calculator 104 succeeds/retains the correlation values for all blocks calculated by motion vector estimator 102, and a correlation value for target block 530 may be selected from these correlation values.

Correlation value 251 in motion vector estimator 102 indicates a degree of correlation, i.e., a degree of relativeness, of blocks pointed by estimated motion vectors 560 and 660 that are detected in reference blocks 510 and 610. Correlation value 1041 in correlation value calculator 104 indicates a degree of correlation, i.e., a degree of relativeness, of blocks pointed by estimated motion vector 580 that is detected in target block 530. Smaller correlation values 251 and 1041 mean higher degree of correlation with a block pointed by the estimated motion vector. This shows correctness, i.e., the high reliability, of calculated estimated motion vector.

Next, motion vector determinator 105 receives estimated motion vector 560 and correlation value 251 that are calculated for reference block 510, and estimated motion vector 580 and correlation value 1041 that are calculated for target block 530. Motion vector determinator 105 determines the motion vector of target block 530 by using these correlation value 251 and correlation value 1041.

More specifically, motion vector determinator 105 compares reference block 510 and target block 530 using correlation value 251 for reference block 510 calculated by motion vector estimator 102 and correlation value 1041 for target block 530 calculated by correlation value calculator 104, or uses other threshold so as to determine the motion vector.

For example, if correlation value 251 (the correlation value for reference block 510) calculated by motion vector estimator 102 is smaller than correlation value 1041 (the correlation value for target block 530) calculated by correlation value calculator 104, estimated motion vector 560 of reference block 510 calculated by motion vector estimator 102 is determined as motion vector of target block 530.

Contrary, if correlation value 1041 for target block 530 is smaller than correlation value 251 for reference block 510, estimated motion vector 580 of target block 530 is determined to have a higher reliability, and thus estimated motion vector 580 is determined as the motion vector of target block 530.

If correlation value 251 for reference block 510 and correlation value 1041 for target block 530 are equal, or their difference is within a certain range, either vector previously specified is determined as a motion vector. Here, the certain range may be determined, for example, by the following calculation:

(Number of pixels configuring the block)×(Range of values that each pixel may have)×Allowance (%).

Another determination method is available. Correlation value 251 for reference block 510 is compared with a predetermined threshold value, and estimated motion vector 560 of reference block 510 is adopted if correlation value 251 is smaller than the threshold value. On the other hand, if correlation value 251 is equal to or greater than the threshold value, estimated motion vector 1041 of target block 530 is adopted. Based on this method, if correlation value 251 for reference block 510 is roughly large, although correlation value 251 for reference block 510 is smaller than correlation value 1041 for target block 530, the reliability of estimated motion vector 560 of reference block 530 is considered low, and estimated motion vector 580 of target block 530 is preferentially adopted.

Still another determination method is available. Correlation value 1041 for target block 530 is compared with a predetermined threshold value, and estimated motion vector 560 of reference block 510 is adopted if correlation value 1041 is larger than this threshold value. On the other hand, if correlation value 1041 is equal to or smaller than this threshold value, estimated motion vector 580 of target block 530 is adopted. In this method, the reliability of estimated motion vector 580 of target block 530 is considered high if correlation value 251 for reference block 510 is smaller than correlation value 1041 for target block 530 and correlation value 1041 for target block 530 is smaller than a certain threshold, and this estimated motion vector 580 is preferentially adopted.

Still another determination method is available. If correlation value 1041 for target block 530 is within a range determined by the minimum value and the maximum value, estimated motion vector 580 of target block 530 is adopted. On the other hand, if correlation value 1041 is not within this range, estimated motion vector 560 of reference block 510 is adopted. With this method, estimated motion vector 580 of target block 530, which is converted, can be preferentially adopted in a range that the reliability of correlation value 1041 for target block 530 is evaluated high.

In addition, a new vector may be calculated from these multiple vectors, instead of mere selection of estimated motion vector 560 of reference block 510 or estimated motion vector 580 of target block 530. For example, a new vector may be generated by adding each vector in proportion to a degree of reliability of the correlation value for each of multiple vectors.

As described above, the embodiment uses the estimated motion vector of the target block calculated also using a motion vector of other block, in addition to the estimated motion vector of the reference block. This enables the effective detection of highly-accurate motion vectors.

The aforementioned characteristics can be utilized for compression-coding of image signals whose movement is compensated using motion vectors, or generation of an interpolated image using motion vectors. Accordingly, the embodiment offers high-quality and highly-efficient processing for compression-coding of image signals whose movement is compensated, or generation of an interpolated image.

In the above description, motion vector estimator 102 and correlation value calculator 104 use the YUV signal as an input for estimating a motion vector. Furthermore, an image signal for HSV color space (hue, saturation, value ) may be input for estimating a motion vector using at least one of these components. In this case, a motion vector can be estimated using a change in components (hue, saturation, value and so on) that are difficult to be detected in luminance.

In the description, correlation value calculator 104 adopts a method of using correlation value 251 calculated by motion vector estimator 102. However, other methods are available. For example, correlation value calculator 104 may be used for re-calculation. In this case, a correlation value may be calculated using a calculation method different from that in motion vector estimator 102. If only a luminance signal is used for calculating the correlation value in motion vector estimator 102, correlation value calculator 104 may adopt a calculation method that uses all pixel components. This enables the detection of further highly-accurate motion vector because a correlation value is calculated using an index different from that used in motion vector estimator 102.

Reference blocks 311, 510, and 610 are collectively called the first reference block. Estimated blocks 520 and 620 are collectively called the first estimated block. Target blocks 530 and 630 are collectively called the second reference block. Estimated motion vectors 560 and 660 of the first reference block are collectively called the first estimated motion vector. Estimated motion vector 580 of the second reference block is collectively called the second estimated motion vector.

### Second Exemplary Embodiment

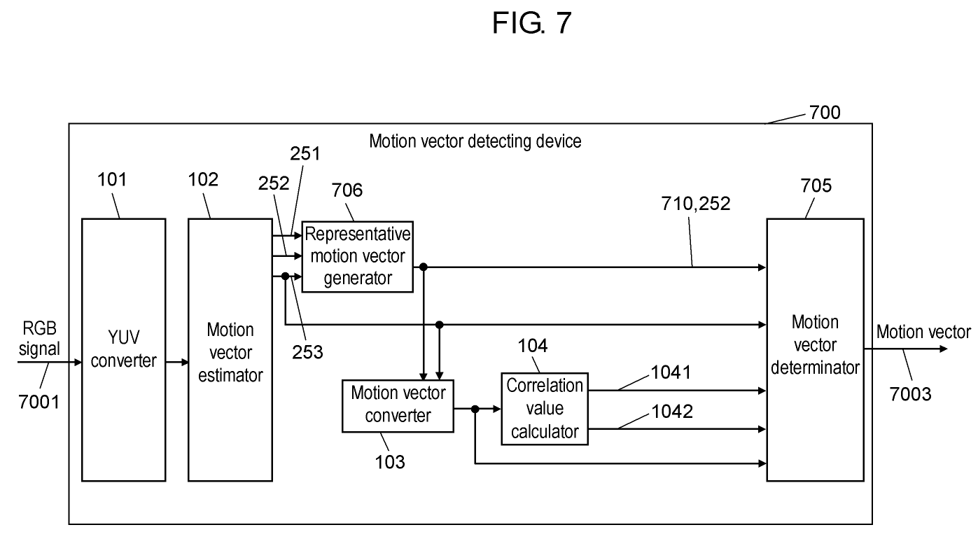

Next, the second exemplary embodiment is described. FIG. 7 illustrates an example of a structure of motion vector detecting device 700 in the second exemplary embodiment. Motion vector detecting device 700 in the second exemplary embodiment differs from motion vector detecting device 100 in the first exemplary embodiment in a point that representative motion vector generator 706 is added, and that internal processing in motion vector determinator 705 is partially different from that in motion vector determinator 105. Therefore, only the points that differ from the first exemplary embodiment are described in the description for the second exemplary embodiment, and other points same as that in the first exemplary embodiment are omitted from the description.

There are image signals, such as for characters, that move in the horizontal direction at a predetermined vertical position on the screen, typically captions and tickers. There are also image signals, such as for characters, that move in the vertical direction at a predetermined horizontal position on the screen, typically credits in movies. In case of these image signals, it can be assumed that there is a high possibility that estimated motion vectors are the same or similar between the reference block and other blocks at the same vertical position on the screen; the reference block and other blocks at the same horizontal position on the screen; or the reference block and blocks around the reference block.

Therefore, representative motion vector generator 706 calculates the motion vector utilizing the above characteristic.

Representative motion vector generator 706 receives estimated motion vector 252 and its correlation value 251 calculated by motion vector estimator 102. Then, representative motion vector generator 706 executes statistical processing, typically average calculation, for motion vectors of the following multiple blocks. The multiple blocks include multiple blocks around reference block 311, multiple blocks at the same vertical position as reference block 311 on the screen, or a block at the same horizontal position as reference block 311 on the screen. Representative motion vector generator 706 generates representative motion vector 710 that indicates typical movement of these multiple blocks.

There are diverse ways of setting multiple blocks around reference block 311. For example, blocks adjacent to reference block 311, blocks within a predetermined distance (range) from a certain point, blocks at a certain distance from reference block 311, or all blocks in the same frame as reference block 311 are set.

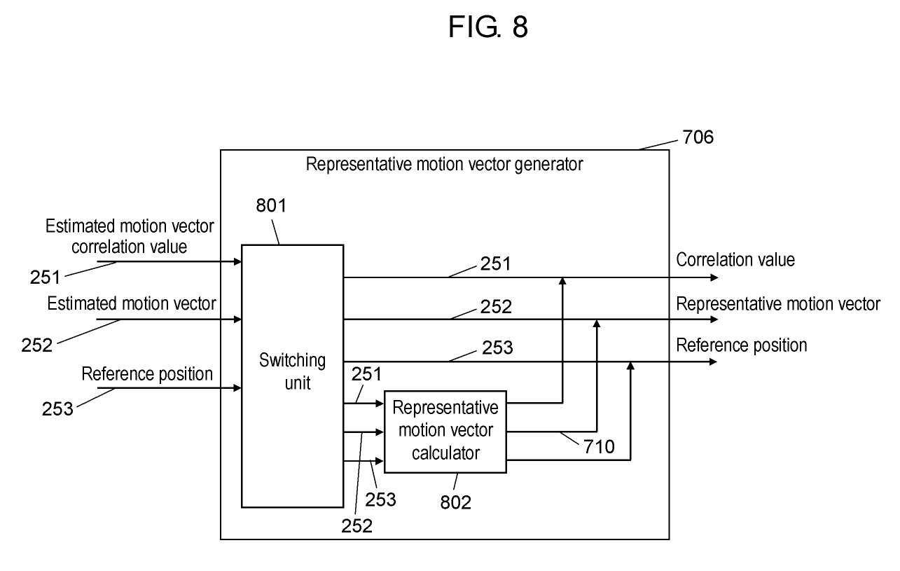

FIG. 8 illustrates an example of the structure of representative motion vector generator 706. Representative motion vector generator 706 receives correlation value 251 for estimated motion vector, estimated motion vector 252, and reference position 253 output from motion vector estimator 102. Switching unit 801 determines whether or not to generate representative vector 710 of reference block 311, based on these pieces of information received.

Switching unit 801 determines whether or not to generate a representative motion vector based on, for example, whether or not the position of reference block 311 on the display screen is at a screen end. Since it is relatively difficult to calculate the motion vector at the screen end, the motion vector can be obtained by using representative motion vector 710 as a motion vector.

In addition, in case that whether or not to generate the representative motion vector is determined in more advanced way an image boundary is logically detected from the input image signal, and representative motion vector 710 can be used for calculating a motion vector near this boundary. Moreover, a display position of caption or ticker or a vertical flow of a string of characters (e.g. credits of a movie) is detected from the content of image signal, and representative motion vector 710 can be used for calculating a motion vector. Switching unit 801 needs to determine whether or not to generate the representative motion vector based on estimated motion vectors of multiple blocks. Accordingly, switching unit 801 may also be equipped with a buffer (memory area) for retaining multiple estimated motion vectors and their correlation values.

If representative motion vector generator 706 does not generate representative motion vector 710, these pieces of information received are output as they exist. In this case, motion vector detecting device 700 executes the same processes as that of motion vector detecting device 100 in the first exemplary embodiment.

If switching unit 801 determines to generate representative motion vector 710, input information is sent to representative motion vector calculator 802.

Representative motion vector calculator 802 specifies a range in which representative motion vector 710 is generated based on input information. This range is, for example, blocks in the same horizontal position, blocks in the same vertical position, or blocks around the reference block. Representative motion vector calculator 802 then generates representative motion vector 710, typically by averaging, from estimated motion vectors 252 within this specified range.

Through the above processing, representative motion vector generator 706 outputs representative motion vector 710.

In this way, representative motion vector 710 generated by representative motion vector generator 706 indicates the movement of an image in reference block 311 and blocks around reference block 311. This representative motion vector 710 is applicable to reference block 311 and blocks around reference block 311 as their motion vectors.

In addition, in the state that a part of the screen moves in the same way, such as captions and tickers, the next movement can be assumed, taking into account the uniformity of the direction of motion vectors. In other words, it can be assumed that blocks in the same direction as representative motion vector 710 starting from reference block 311, generated by representative motion vector generator 706, in blocks around reference block 311 take the same movement as this representative motion vector 710.

Representative motion vector 710 generated by representative motion vector generator 706 is output to motion vector converter 103 and motion vector determinator 705. Estimated motion vector 252 is converted by motion vector converter 103 in the same way as that in the first exemplary embodiment, and correlation value calculator 104 calculates correlation value 1041. Motion vector determinator 805 determines and outputs motion vector 7001, depending on representative motion vector 710 and converted motion vector.

Motion vector determinator 705 determines motion vector 7001 based on representative motion vector 710 from representative motion vector generator 706 and correlation value 1041 from motion vector converter 103 and correlation value calculator 104.

Unlike motion vector detecting device 100 in the first exemplary embodiment, motion vector detecting device 700 in the second exemplary embodiment receives only representative motion vector 710, and not correlation value, from representative motion vector generator 706. Accordingly, motion vector determinator 705 in motion vector detecting device 700 compares correlation value 1041 from correlation value calculator 104 and a predetermined threshold, and determines which vector to use as a motion vector. The threshold and correlation value 1041 are compared in the same way as that in the first exemplary embodiment, and thus its description is omitted here.

Other components in motion vector detecting device 700 are the same as those in motion vector detecting device 100 in the first exemplary embodiment and thus their description is also omitted here.

As described above, motion vectors can be calculated further accurately by adding representative motion vector generator 706 when there is a distinctive movement on the screen.

### Third Exemplary Embodiment

The motion vector detecting devices 100 and 700 are described in the first and second exemplary embodiments. However, such devices are not limited to these embodiments. The functions of such devices described above can be realized in the form of electronic circuits and electric circuits. Moreover, the devices may be realized in the form of an integrated circuit (an IC chip and semiconductor chip). Furthermore, the devices may be realized in the form of software running on a CPU.

Now, a motion vector detecting device of the present invention achieved in the form of software running on a CPU is described below.

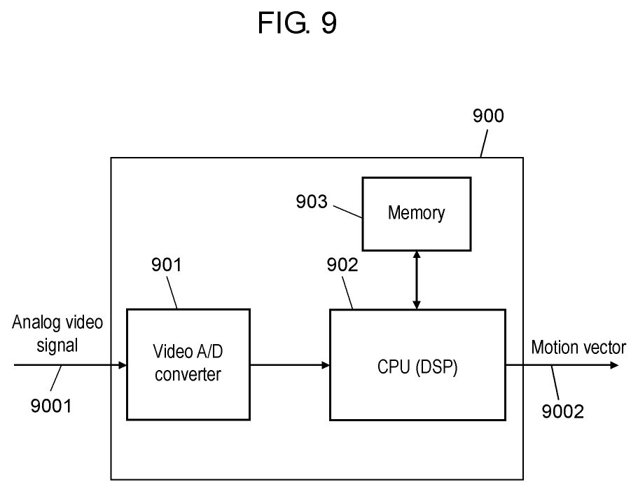

In case the motion vector detecting device is realized in the form of software, an example of the hardware configuration executing the software is shown in FIG. 9. In FIG. 9, motion vector detecting device 900 realized in the form of software includes video A/D converter 901, CPU (DSP) 902, and memory 903.

In FIG. 9, for example, video A/D converter 901 converts input analog image signal 9001 to RGB digital signal, and input it to CPU (DSP) 902. CPU (DSP) 902 can detect and output motion vector 9002 by executing software that has functions and structure described in the aforementioned first and second exemplary embodiments. Frame data and data on correlation values that need to be temporarily retained in motion vector estimator 102 and correlation value calculator 104 are stored in memory 903 connected to CPU (DSP) 902.

As described above, the devices are not limited to a hardware configuration such as a module that is a part of the function of devices including electric circuits or electronic circuits, a processor unit such as a motion vector detecting device for achieving the function, or an integrated circuit to which the function is built in. The devices are also realizable in the form of software running on an arithmetic device such as CPU, MPU, and DSP.

The above-described first, second, and third exemplary embodiments refer to the case of configuring input image signals in units of frame. However, the embodiments are not limited to this configuration. The embodiments are also applicable even if input image signals are configured in units of field. If the input image signal is configured in units of field, a predetermined search range set by motion vector estimator 102 includes at least one field that is before or after the field including reference block 311.

The exemplary embodiments are given to illustrate using examples, and thus all of the possible embodiments are not limited to the exemplary embodiments.

As described above, the embodiments enable the detection of motion vectors more accurately.

The embodiments are realizable in the form of a motion vector detecting circuit, motion vector detecting device, and integrated circuit or software that has these functions. Furthermore, the embodiments are applicable to coding technology of MPEG and H262 that digitally compresses images, and frame/field interpolation technology for display devices.

What is claimed is:

1. A motion vector detecting device comprising:
a motion vector estimator for calculating:
an estimated motion vector that is a motion vector estimated for a reference block, the reference block being a partial area of a display screen configuring an image signal; and
a correlation value between an estimated block pointed by the estimated motion vector and the reference block;
a motion vector converter for calculating a second reference block in response to a first estimated motion vector calculated by applying the motion vector estimator to a first reference block;
a correlation value calculator for calculating a second correlation value that is a correlation value calculated by applying the motion vector estimator to the second reference block; and
a motion vector determinator for determining and outputting a motion vector of the second reference block based on at least one of:
at least one of a first correlation value calculated by applying the motion vector estimator to the first reference block or the second correlation value;
the first estimated motion vector; or
a second estimated motion vector calculated by applying the motion vector estimator to the second reference block.

2. The motion vector detecting device of claim 1, wherein the motion vector converter sets a position pointed by a motion vector as the second reference block, the motion vector having a direction that is substantially the same as, or opposite to, the first estimated motion vector.

3. The motion vector detecting device of claim 1, wherein the motion vector converter sets a position pointed by a motion vector as the second reference block, the motion vector having substantially a same absolute value as that of the first estimated motion vector.

4. The motion vector detecting device of claim 1, wherein the motion vector converter sets a position pointed by a motion vector as the second reference block, the motion vector being generated by adding the first estimated motion vector and a motion vector having a direction that is substantially the same as or opposite to, the estimated motion vector.

5. The motion vector detecting device of claim 1, wherein the motion vector converter sets a position pointed by a motion vector as the second reference block, the motion vector being generated by multiplying the first estimated motion vector.

6. The motion vector detecting device of claim 1, wherein the motion vector converter calculates a plurality of the second reference blocks relative to the first estimated motion vector.

7. The motion vector detecting device of claim 1, wherein the motion vector determinator outputs the first estimated motion vector as the motion vector when the first correlation value is not greater than the second correlation value.

8. The motion vector detecting device of claim 1, wherein the motion vector determinator outputs the first estimated motion vector as the motion vector when the first correlation value is smaller than a threshold value.

9. The motion vector detecting device of claim 1, wherein the motion vector determinator outputs the first estimated motion vector as the motion vector when the second correlation value is larger than a threshold value.

10. A motion vector detecting device comprising:
a motion vector estimator for calculating:
an estimated motion vector that is a motion vector estimated for a reference block, the reference block being a partial area of a display screen configuring an image signal; and
a correlation value between an estimated block pointed by the estimated motion vector and the reference block;
a representative motion vector generator for calculating a representative motion vector that represents a plurality of the estimated motion vectors based on the plurality of estimated motion vectors and the correlation value;
a motion vector converter for calculating a second reference block in response to a first representative motion vector calculated by applying the motion vector estimator and the representative motion vector generator to a first reference block;
a correlation value calculator for obtaining a second correlation value that is a correlation value calculated by applying the motion vector estimator to the second reference block; and
a motion vector determinator for determining and outputting a motion vector of the second reference block based on at least one of:
the second correlation value;
the first representative motion vector; or
a second estimated motion vector calculated by applying the motion vector estimator to the second reference block.

11. The motion vector detecting device of claim 10, wherein the representative motion vector generator generates the first representative motion vector based on an estimated motion vector of the first reference block and an estimated motion vector of a different block.

12. The motion vector detecting device of claim 11, wherein the different block is a block adjacent to the first reference block.

13. The motion vector detecting device of claim 11, wherein the different block is a block at a same horizontal position as the first reference block.

14. The motion vector detecting device of claim 11, wherein the different block is a block at a same vertical position as the first reference block.

15. The motion vector detecting device of claim 10, wherein the motion vector converter sets a position pointed by a motion vector as the second reference block, the motion vector having a direction that is substantially the same as, or opposite to, the first representative motion vector.

16. The motion vector detecting device of claim 10, wherein the motion vector converter sets a position pointed by a motion vector as the second reference block, the motion vector having substantially a same absolute value as that of the first representative motion vector.

17. The vector detecting device of claim 10, wherein the motion vector converter sets a position pointed by a motion vector as the second reference block, the motion vector being generated by adding the first representative motion vector and a motion vector having a direction that is substantially the same as, or opposite to, the first representative motion vector.

18. The motion vector detecting device of claim 10, wherein the motion vector converter sets a position pointed by a motion vector as the second reference block, the motion vector being generated by multiplying the first representative motion vector.

19. The motion vector detecting device of claim 10, wherein the motion vector converter calculates a plurality of the second reference blocks relative to the first representative motion vector.

20. The motion vector detecting device of claim 10, wherein the motion vector determinator determines and outputs the first representative motion vector as the motion vector when the second correlation value is greater than a threshold value.
